(19) United States
(12) Patent Application Publication
(10) Pub. No.: US 2002/0143562 A1
(43) Pub. Date: Oct. 3, 2002

(54) Automated legal action risk management

(76) Inventor: David Lawrence, New York, NY (US)

Correspondence Address: Clifford Chance Rogers & Wells LLp, 200 Park Avenue, New York, NY, 10166-0153, US

(21) Appl. No.: 09/825,470

(22) Filed: Apr. 2, 2001

(51) Int. Cl. G06F 17/60

(52) U.S. Cl. 705/1

(57) ABSTRACT

A risk management method and system for facilitating analysis and quantification of risks associated with a legal action. An automated legal action risk management (ALARM) system maintains a legal action database including factual data and editorial content, and relates the data to a legal action. A rating system is used to assess risks based upon risk assessment factors such as data descriptive of parties to a legal action, individuals advising and/or controlling the parties to a legal action, historical data, interpretation of world events or other associated input. The system generates a risk quotient or other qualitative rating based upon a weighted algorithm applied to the risk assessment factors. Actions responsive to and commensurate with a legal risk quotient can be generated to help a user properly manage risk associated with a particular legal action or an aggregate of legal actions.

### BACKGROUND

This invention relates generally to a method and system for facilitating the identification, investigation, assessment and management of legal, regulatory financial and reputational risks (“Risks”). In particular, the present invention relates to a computerized system and method to access information compiled on a worldwide basis, and utilize the information to assess the risks associated with a legal action.

Corporate entities, institutions, limited liability partnerships, limited liability companies, partnerships, bank and non-bank financial institutions, including: investment banks; merchant banks; commercial banks; securities firms, including broker dealers securities and commodities trading firms; asset management companies, securities exchanges and bourses, law firms, accounting firms, auditing firms and other entities, hereinafter collectively referred to as “Institutions,” typically have few resources available to them to assist in the identification of present or potential risks associated with opening a particular investment or trading account. Risk can be multifaceted and far reaching. Generally, personnel responsible for decision making associated with risks do not have available a mechanism to provide real time assistance to assess a risk factor or otherwise qualitatively manage risk. In the event a legal issue arises, it is often difficult to quantify to regulatory bodies, shareholders, newspapers and other interested parties, the diligence exercised by the institution or other entity to properly identify and respond to risk assessment factors 116. Absent a means to quantify good business practices and diligent efforts to contain risk, an institution may appear to be negligent in some respect.

Risk associated with entering into and/or participating in a legal action can include factors associated with financial risk, legal risk, regulatory risk and reputational risk. Financial risk includes factors indicative of monetary costs that the financial institution may be exposed to as a result of opening a particular account and/or transacting business with a particular client. Monetary costs can be related to fines, forfeitures, cost to defend an adverse position, or other related potential sources of expense. Regulatory risk includes factors that may cause the financial institution to be in violation of rules put forth by a regulatory agency such as the Securities and Exchange Commission (SEC). Reputational risk relates to harm that a financial institution may suffer regarding its professional standing in the industry. A financial institution can suffer from being associated with a situation that may be interpreted as contrary to an image of honesty and forthrightness.

Situations involving assertion or enforcement of one aspect or another of an applicable rule of law can include legal action, arbitration, regulatory action, audit by a government agency or other authority, a criminal proceeding, hereinafter referred to as “Legal Actions.”

The uncertainties of litigation are well known. Similarly, legal actions in general have unique and diverse variables associated with their associated risks. Decisions relating to legal action need to consider numerous factors in order to be able to adequately assess the risk involved with a legal action. Some factors may include: whether a legal action could involve a class action status; is the issue safety related; the geographic area of occurrence, the demographics of the occurrence; the jurisdiction; any regulatory interest; political aspirations of a participant or prosecutor; does it involve a natural constituency; does it involve a voting bloc; what public relations qualities or implications are involved; and other associated considerations.

Risk associated with a legal action can be greatly increased as compared to other corporate endeavors due to the difficulty in gathering, accessing, and appropriately analyzing pertinent data on a basis timely to managing risk associated with the legal action.

In-house counsel, corporate officers and other personnel responsible for limiting exposure to risk associated with legal actions typically have few resources available to assist them with the identification of present or potential risks associated with a particular legal action or proposed legal action. Risk can be multifaceted and far reaching. The amount of information that needs to be considered to evaluate whether particular legal action poses a significant risk or should otherwise be restricted or avoided, can be substantial.

Corporate counsel and other decision makers need a mechanism which can provide real time assistance to assess a risk factor associated with a legal action, and/or otherwise qualitatively manage such risk.

What is needed is a method and system to draw upon information gathered globally and utilize the information to assist with risk management and due diligence related to legal actions. It would be useful to have a method and system that can anticipate offering guidance to personnel who are responsible for initiating or dispensing with legal issues and help the personnel identify high risk situations. In addition, it should be situated to convey risk information to legal, corporate, and/or compliance departments and be able to demonstrate to regulators that an institution has met reasonable standards relating to risk containment.

### SUMMARY

Accordingly, the present invention provides a risk management method and system for facilitating analysis and quantification of risks associated with a legal action. An automated legal action risk management (ALARM) system maintains a legal action database including factual data and editorial content, and relates the data to a legal action. A rating system is used to assess risks based upon criteria such as data descriptive of parties to a legal action, individuals advising and/or controlling the parties to a legal action, historical data, interpretation of world events or other associated input. The system generates a risk quotient or other qualitative rating based upon a weighted algorithm applied to the criteria, wherein the risk quotient is indicative of Risks associated with an account. The quotient can be calculated and/or monitored on a periodic basis, during the course of legal action, prior to commencing or responding to a legal action, or on demand. Actions responsive to and commensurate with a legal risk quotient can be generated to help an institution properly manage risk associated with a particular legal action.

A log or other stored history can be created such that utilization of the system can mitigate adverse effects relating to a problematic legal action. Mitigation can be accomplished by demonstrating to regulatory bodies, shareholders, news media and other interested parties that corporate governance is being addressed through tangible risk management processes. Mitigation can also be accomplished by choosing a course of action that best responds to all of the risks, even if the course of action does not include a most decisive remedy available through the law.

A legal action risk management system user may include, for example, a corporate entity, a limited liability company, a law firm, a consulting firm, a bank, a trading institution, an insurance company, a credit card issuer, a trading exchange, a government regulator, a law enforcement agency and any other entity affected by a legal action. Implementations can include in-house systems receiving updated data content, or a network accessible system.

In another aspect, a computer system for providing risk management relating to legal actions can include a computer server that is accessible with a network access device via a communications network and executable software stored on the server that is executable on demand via the network access device. The software can be operative with the server to receive information relating to risk assessment factors and formulate a risk quotient or other rating.

Other embodiments include computer executable program code residing on a computer-readable medium, a computer data signal embodied in a digital data stream, or a method of interacting with a network access device designed to assist a user quantify Risks associated with a legal action. Various features and embodiments are further described in the following figures, drawings and claims.

### DESCRIPTION OF THE DRAWINGS

FIG. 1 contains a block diagram illustrating major functions involved in the present invention.

FIG. 2 illustrates a network of computer systems that can embody an ALARM system.

FIG. 3 illustrates a flow of exemplary steps that can be executed by an ALARM system.

FIG. 4 illustrates a flow of exemplary steps that can be executed by a user of the ALARM system.

FIG. 5 illustrates an exemplary graphical user interface useful for gathering information according to the present invention.

FIG. 6 illustrates an exemplary graphical user interface useful for presenting reports related to ALARM.

### DETAILED DESCRIPTION

The present invention includes a computerized method and system for managing risk associated with legal actions. A computerized system gathers and stores information in a database or other data storing structure and relates the information to risk assessment factors 116 pertaining to a particular legal action. A rating system is used to assess risk based upon the information gathered and the risk assessment factors 116. A rating, such as a risk quotient 110 is generated to readily indicate a level of risk associated with a particular legal action or proposed response to same. The risk quotient 110 can be based upon a weighted algorithm applied to the risk assessment factors 116. The risk quotient 110 can be made available on a periodic basis, on demand in real time, in response to an event such as a latest development in a litigation, or according to some other request. Actions commensurate with a risk level can be generated and presented to assist with proper risk management.

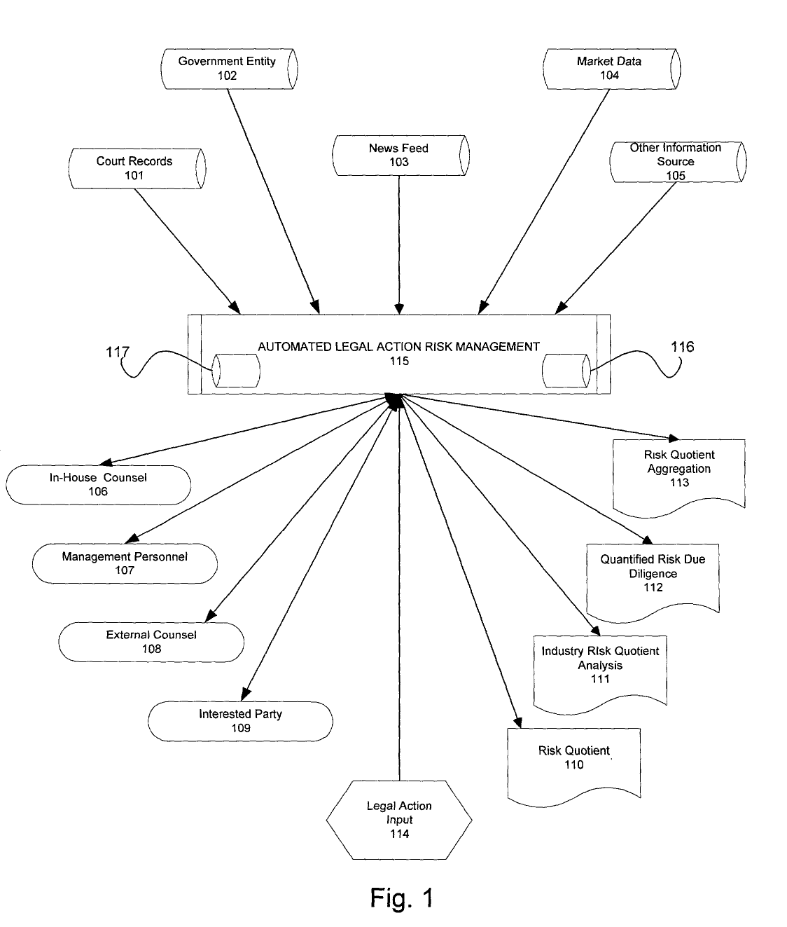

Referring now to FIG. 1 a block diagram of one embodiment of the present invention is illustrated. A computerized ALARM system 115 receives and stores general information from a variety of general information sources 101-105. Sources can include for example, court records 101, such as: judicial opinions, historical tendencies of a particular court or judge, historical data concerning juries according to venue or demographic makeup, average length of a trial, ratio of decisions favoring plaintiffs according to a type of issue litigated, ratio of conviction for a particular type of crime, historical sentencing for a particular offense, or other data relating to legal proceedings, such as arbitration awards or time to resolution for an arbitration.

Another source of information can include regulations or guidelines generated by a governmental entity 102. A governmental entity 102 may include for example: the Securities and Exchange Commission, the Internal Revenue Service, the Justice Department, the Office of Foreign Access Control (OFAC), the U.S. Commerce Department, the White House, or other authority from a local zoning board to a foreign government. Other sources of information may include, for example, publications issued by Treasury's Financial Crimes Enforcement Network (“FinCEN”), the State Department, the CIA, the General Accounting Office, Congress, the Financial Action Task Force (“FATF”), various international financial institutions (such as the World Bank and the International Monetary Fund), the United Nations, non-government organizations, internet websites, news feeds, commercial databases, or other information sources.

Sources of information can also include a news feed 103 such as Lexis-Nexis™ or Bloomberg™ or market data 104 such as an electronic data feed with information related to various national or regional exchanges. Other sources of information 105 can include almost any form of information that could relate to Risks and possible implications associated with a legal actions, such as, but not limited to: demographic data, political events, political agendas, market forces, social trends, economic climate, acts of God or war, scientific or technological advances, communication vehicles or special interest groups.

Input descriptive of a Legal Action 114 is received by the ALARM system 115. The Legal Action Input 114 can be input by one more associated entities 106-109 having knowledge related to various aspects of the Legal Action, such as, for example an in-house counsel 106, management personnel 107, external counsel 108, an interested party 109, or any other person capable of supplying pertinent information. Legal Action Input can be input prior to commencement of the action or during the action as circumstances may change, or additional information becomes available.

Included in the Legal Action Input 114 can be the type of action, the venue, the parties directly affected by the Legal Action, parties indirectly affected by the Legal Action, financial amounts associated with the Legal Action, the timing of the Legal Action, associated events, business concerns associated with the Legal Action, searchable key words related to important aspects of the legal action, political figures involved, political issues affected by the legal action, precedents that may be set by the legal action, related legal actions, and almost any other information that may be utilized useful to link the legal action with risk assessment factors 116. Input can be accomplished via a natural language dialogue via a graphical or textual user input or through voice audio input, via structured input fields, via interactive questions or other input devices as discussed more fully below.

A decision by an Institution that is related to a legal action, or can be affected by a legal action, can be dependent upon many risk assessment factors 116. A multitude and diversity of risk assessment factors 116 may need to be identified and evaluated. In addition, the weight and commercial implications of various assessment factors as well as associated risks can be interrelated. The present invention can provide a consistent and uniform method for a business, legal, compliance, credit and other entity to identify, correlate, quantify and assess Risks associated with a Legal Action and thereby assess legal, regulatory, financial and reputational exposure.

The ALARM system 115 receives the input information relating to financial, legal, regulatory and/or reputational risk and associates the input with one or more risk assessment factors 116. The computerized ALARM system 115 can accomplish this through artificial intelligence routines, branching routines, keyword association, directly linking field inputs to a risk assessment factor. Risk assessment factors 116 can also be related to the general information received from the general information sources 101-105. If desired, risk assessment factors 116 can be stored as a relative database allowing for ease of manipulation and/or evaluation. Other database or storage mechanisms may also be utilized. Not all risk assessment fields need to contain a value if the information is not available. In some instances, an empty field due to lack of available information can also be indicative of an amount of risk.

The ALARM system 115 can apply an algorithm that weights the risk assessment factors 116 and calculates a risk quotient 110 or similar score or rating based upon the weighted risk assessment factors 116. The risk quotient can include, for example, a scaled numeric or alphanumeric value indicative of a relative amount of risk associated with the legal action. The risk quotient 110 can offer a unique and summary risk quantifier whereby, for example, a decision maker can ascertain that proceeding with a Legal Action presents a level 10 risk according to a derived risk quotient and a level 10 risk is relatively benign compared to a level 100 risk which might represent considerable legal, regulatory financial and reputational Risks.

The weight allocated to a particular risk assessment factor 116 can vary according to a value in another one or more other risk assessment factors 116. Alternatively, a particular risk assessment factor 116 can have a predetermined weight.

In response to a risk quotient 10 and/or in conjunction with information input as risk assessment factors 116, the ALARM system 115 can generate a suggested action 117. Suggested actions 117 may include an alternate Legal Action, pursuit of a particular legal strategy, or avoidance of the Legal Action. A legal strategy can include almost any legal tactic, such as: change of venue; seeking recusal of a judge; a counter claim; seek arbitration as opposed to of litigation; seek litigation as opposed to arbitration; seeking to settle a claim; a rigorous, scorched earth approach; or any other action that is related to the circumstances at hand and can be supported by the Legal Action Input 114. A suggested action 117 can be made available to associated entities 106-109 via a GUI, messaging, reporting or other communication.

Although a primary use for the present invention is to quantify risk associated with a particular Legal Action, an ALARM system 115 can also be used for other purposes. One alternative use of an ALARM system 115 can include an industry risk quotient analysis 111 that calculates a mathematical function of risk quotients for various entities comprising an industry. For example, it may be useful to ascertain an average risk quotient for the oil products industry based upon litigations commenced, or a sum of risk quotients for the oil products industry based upon litigations commenced and filed arbitrations.

As an ALARM receives updated legal action input 114, the risk quotient will be subject to change. If a Legal Action reaches or exceeds a risk quotient threshold, the ALARM system 115 can respond with a predetermined action, such as, for example, generating an alert, creating a report, notifying a legal or management personnel, or other appropriate response.

In addition, the system can create a structured history relating to a Legal Action that can quantify due diligence 112 and proper corporate governance. An ALARM system can create a log or other stored history quantifying information considered and steps taken to address a particular Legal Action. Reporting can be generated from the structured history. Once quantified, due diligence data can be utilized to demonstrate to shareholders, corporate board members, management, regulatory bodies, or a court or mediator that specific diligence steps were followed in relation to a particular Legal Action. The data can demonstrate that corporate governance is being addressed through tangible risk management processes.

In order to assist with legal action input 114, questions can be systematically presented by to an entity that desires to input information related to the Legal Action. Questions can relate to any risk assessment factor 116 and can also be presented in several similar and yet different ways, such that related information can be accurately ascertained. Other embodiments can present set data fields to receive information or open text or voice input. Questions or prompts proffered by the ALARM system 115 can also depend from previous answers. Information received in response to the questions can be input into the ALARM system 115 from which it can be utilized for ALARM risk assessment and generation of an ALARM risk quotient 110.

The ALARM risk assessment factors 116 and ALARM risk quotient 110 can also be made available by the ALARM system 115 to an institution or interested entities 106-109. In one embodiment, the ALARM risk quotient can be made available in real time. A real time assessment can allow the ALARM system 115 to provide a suggested action 117 which can be taken to address a particular risk quotient.

The ALARM system 115 can also aggregate risk quotient scores 110 to assess a level of ALARM risk being tolerated by a particular institution. Other calculations, such as, for example, the sum, mean, average, or other calculation can be made by the ALARM system 115 to further analyze ALARM risk at a particular institution.

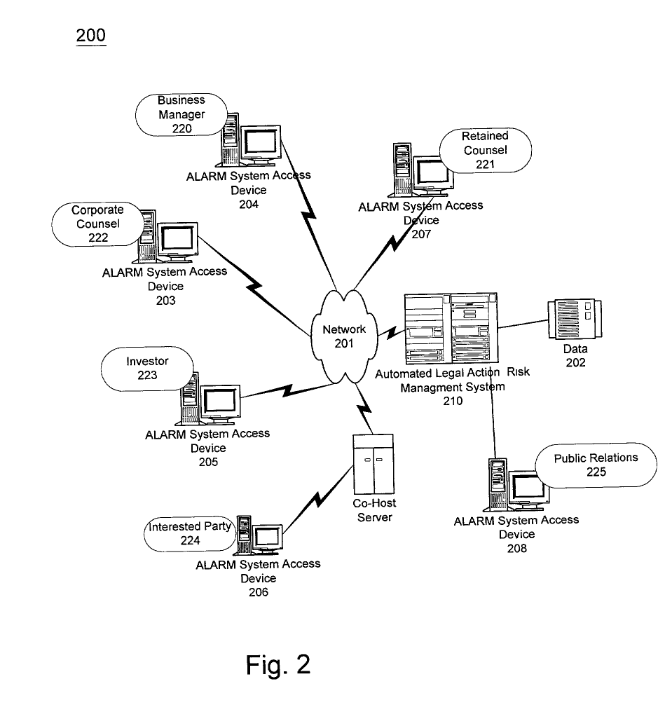

Referring now to FIG. 2, a diagram illustrating one embodiment of the present invention is shown. An automated ALARM system 115 can include a computerized ALARM server 210 accessible via a distributed network 201 such as the Internet, or a private network. A client 220-222, regulatory entity 226, compliance entity 223, account opening personnel 224, corporate compliance personnel 228 or other party interested in ALARM risk management, can use a computerized system or network access device 204-208 to receive, input, transmit or view information processed in the ALARM server 210. A protocol, such as the transmission control protocol internet protocol (TCP/IP) can be utilized to provide consistency and reliability. Direct access to the ALARM server 210 is also be accomplished through a network access device 208 or a stand alone ALARM computer can be utilized.

Each network access device can include a processor, memory and a user input device, such as a keyboard and/or mouse, and a user output device, such as a display screen and/or printer. The network access devices 204-208 can communicate with the ALARM server 210 to access data stored at the ALARM server 210. The network access device 204-208 may interact with the ALARM server 210 as if the ALARM server 210 was a single entity in the network 200. However, the ALARM server 210 may include multiple processing and database sub-systems, such as cooperative or redundant processing and/or database servers, that can be geographically dispersed throughout the network 200. In some implementations, groups of network access devices 204-207 may communicate with ALARM server 210 through a local area network.

The ALARM server 210 includes one or more databases 202 storing data relating to Legal Action risk management. The ALARM server 210 may interact with and/or gather data from an operator of a network access device 204-208, operators may include, for example, a business manager 220, a retained counsel 221, corporate counsel 222, an investor 223, an interested party 224, a public relations person 225 or other person in control of a network access device 204-208. Data gathered from an operator may be structured according to risk assessment factors 116 and utilized to calculate an ALARM risk quotient 110.

Typically an operator or other user will access the ALARM server 210 using client software executed at a network access device 204-208. The client software may include a hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the ALARM server 210 to the client computer and executed at the client network access device or computer as part of the ALARM system software. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

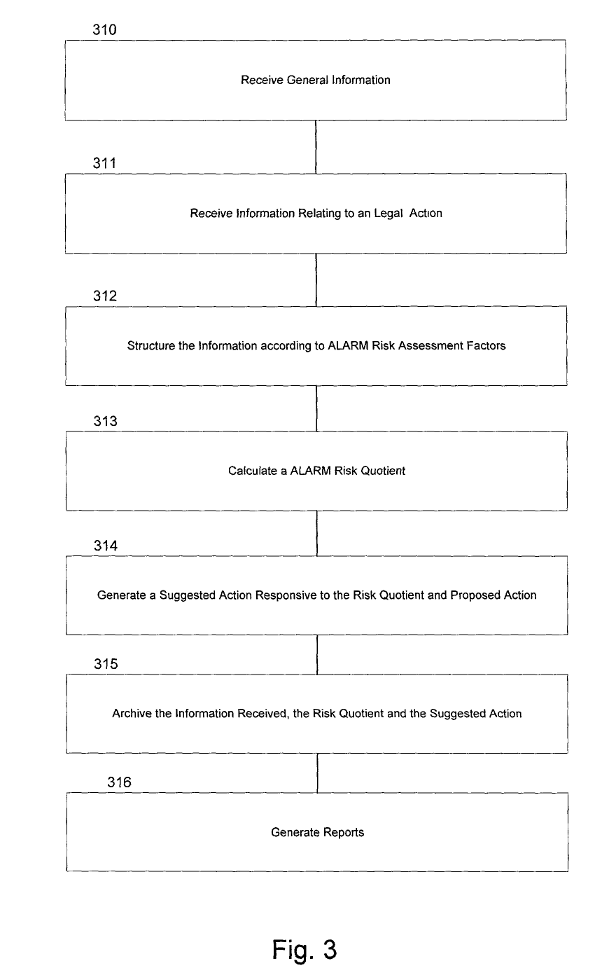

Referring now to FIG. 3, steps taken to manage risk associated with a financial transaction with legal action risk exposure can include receiving general information 210 which can be related to information received descriptive of a particular legal action 211. As described above, general information data can be gathered from a user or from a source of electronic data such as an external database, messaging system, news feed, government agency, or other automated data provider. Information can be received on an ongoing basis such that if new events occur in the world with bearing upon a Legal Action, the Risk Quotient 110 can be adjusted accordingly.

The ALARM server 210 can structure the information received according to defined ALARM risk assessment factors 312. For example, previous opinions by a presiding judge may indicate a propensity towards strong anti-trust sentiments, or a Legal Action affecting a political topic may become a catalyst for action by a public action committee or other special interest group. Information can be received into a form on a GUI or in response to a question presented on a GUI whereby it can be input directly into a related field in a database. Information can also be received as general text, or other manner that is more difficult to direct straight into a field. General text or other information that does not correlate with a data field layout can be analyzed with artificial intelligence, key word association, or other programmed analysis to structure it according to the ALARM risk assessment factors 312.

The ALARM server 210 can also receive information in a pre-structured format or according to a predefined criterion correlating to risk assessment factors 116. Receiving the information in a pre-structured format allows the ALARM server 210 to store the information directly without further analysis and still have it retrievable according to risk assessment factor 116. Information that cannot be easily structured can also be received and archived in order to facilitate a manual qualitative evaluation.

A ALARM risk quotient can be calculated 313 by weighting the risk assessment factors 116 according to their relative risk, such as the likelihood of prolonged litigation, substantial damages, punitive actions, damaged public opinion or other adverse affects related to Risk. Calculating a ALARM risk quotient can be accomplished by assigning a numerical value to each risk assessment factor 116, wherein the numerical value is representative of the risk associated with a particular piece of information, or a combination of pieces of information. For example, it may be determined in one case that a litigation poses significant advantages with a very strong position that has a good chance of being resolved through a summary judgment before an issue friendly judge. Therefore this information from the first case is assigned a low numerical value, or even a negative numerical value. In a second case, an issue may involve subject matter that is sensitive politically or to public relations. Information conveying this type of subject matter with high risk may be assigned a high numerical value. In addition, a weight can be assigned to an ALARM risk assessment factor 116 to which the information is assigned. A Risk Quotient can be calculated by multiplying a weighted numerical value indicative of how important a risk assessment factor 116 may be in regards to Risk times a value assigned according to the information contained in the risk assessment factor to obtain a risk factor value. The risk factor values may then be summed to obtain the Risk Quotient 110.

For example, information received may indicate a potential litigation would be before a court that has previously issued strong opinions adverse to a client's position. In addition, the subject matter of the potential litigation may be particularly sensitive in the political arena. The risk assessment factor 116 assigned to the court may be a numerical value of 8 indicating a high risk with a weight of 10 given to court positions. In addition, the subject matter may also be rated at an 8 because of the risk associated with the political climate and political climate may have a weight of 7 according to its location and breadth of coverage. On the other hand, the client may have strong evidence in support of their position, which may receive a 1 because it is a relatively low risk. Evidence may also have a risk factor value of 10. Also, the subject matter of the legal action may not be a core interest to the client wherein this risk factor may be assigned a value of 3, with interest to client having an assigned weight of 5. Therefore, the net score for this example would be 8 times 10 or 80 plus 8 times 7 or 56 plus 3 times 10 or 30 plus 3 times 5 or 15 for a sum of 181, which is the Risk Quotient.

A suggested action can be generated that is responsive to the Risk Quotient 314. For example, in response to a substantial risk indicated by a large value for a Risk Quotient, a suggested action may be to not proceed with a legal transaction or to settle a pending action. In response to a low risk score, the ALARM server 210 may respond by generating a course of action recommending pursuit of a legal action, and/or a strategy that may be executed to pursue the action. Intermediate scores may respond by suggesting that additional information be gathered, that various aspects of the legal action be monitored, or other interim measures.

The ALARM server 210 can also store, or otherwise archive ALARM data and proceedings. For example the ALARM server 210 can store information received, a Risk Quotient generated, and also any suggested actions that have been generated and/or taken by a client 315. This information can be useful to quantify corporate governance and diligent efforts to address high risk situations. Accordingly, reports quantifying ALARM risk management procedures, executed due diligence, corporate governance or other matters can be generated 316.

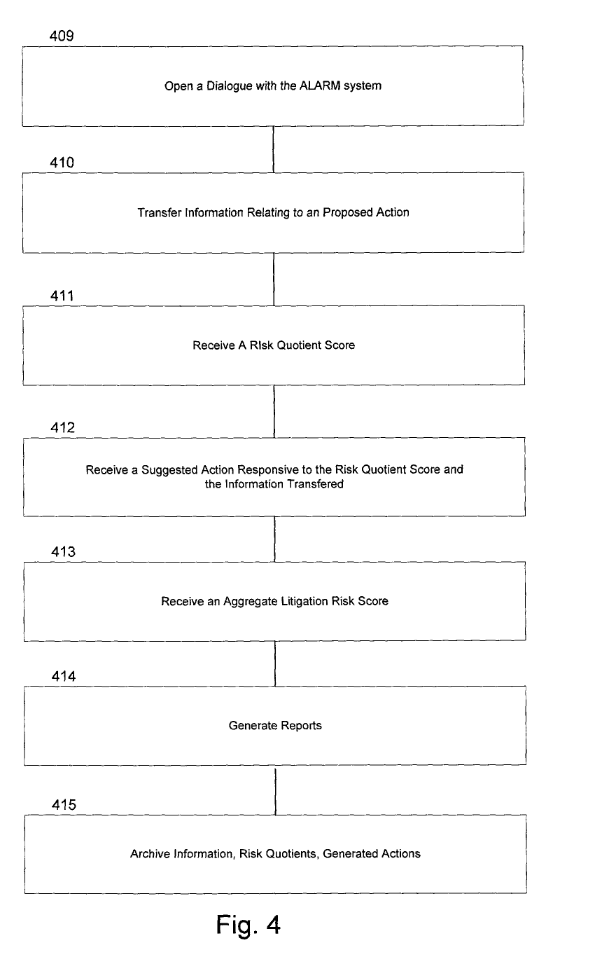

Referring now to FIG. 4, a flow chart illustrates steps that a user, such as a corporate counsel, can execute in order to make use of an ALARM system 115. The user can transfer information relating to a proposed legal action 410 to an ALARM system server 210. This information may be received during the normal course of business, such as when counsel ascertains that a legal action may be necessary to address a situation. The counsel can access an ALARM server 210 and identify to the ALARM server 210 one or more entities, jurisdictions, or other risk variables involved in the transaction 411. Access can be accomplished by opening a dialogue with an ALARM system 409. Typically, the dialogue would be opened by presenting a GUI to a network access device accessible by a person or an electronic feed that will enter information relating to the account holder. The GUI will be capable of accepting data input via a network access device. An example of a GUI would include a series of questions relating to a legal action. Alternatively, information can be received directly into fields of a database, such as from a commercial data source. Questions can be fielded prior or during a pending action.

In one embodiment, automated monitoring software can run in the background of a normal transaction program and screen data traversing one or more applications running on an institution's computer systems. The screened data can be processed to determine key words wherein the key words can in turn be presented to the ALARM server 210 as input to risk assessment factors. Monitoring software can also be installed to screen data traversing a network or communications link.

After inputting information relating to a legal action, the ALARM system will process the information and calculate a risk quotient 110 and present it to the user. The user will receive the risk quotient score 411 for example via a GUI, or via a message, such as an e-mail message. Other variations allow for the risk quotient to be presented in a report. As addressed more completely above, the risk quotient is typically a scaled numerical score based upon values for weighted criteria. It will represent a magnitude of risk associated with a particular transaction and be based upon the factors involved in the legal action.

In addition to receiving the ALARM risk quotient 411, the user can also receive one or more suggested actions responsive to the risk quotient 412, as well as information transferred relating to the legal action. A suggested action can include strategic steps that can be taken by the user or institution to address one or more Risks that are associated with the legal action. The user can also generate reports to quantify the archived information and otherwise document diligent actions taken relating to risk management.

An aggregate litigation risk score can also be received by a user 413 to assess and/or quantify the total risk a user, organization, institution, industry or other entity is exposed to. The aggregate can be useful, for example, for comparing Risks to which competitor institutions are exposed to, in order to assess the strength of the market position.

Reports can be generated by the ALARM system server 210 and received by the user to present the findings related to legal Action Risks and/or to demonstrate proper corporate governance 414.

The user can also archive information relating to risk associated with a transaction as well as steps taken to address the risk 415. The process involved in utilizing the ALARM system can be included in the archive as steps taken to diligently manage risk associated with a legal action transaction.

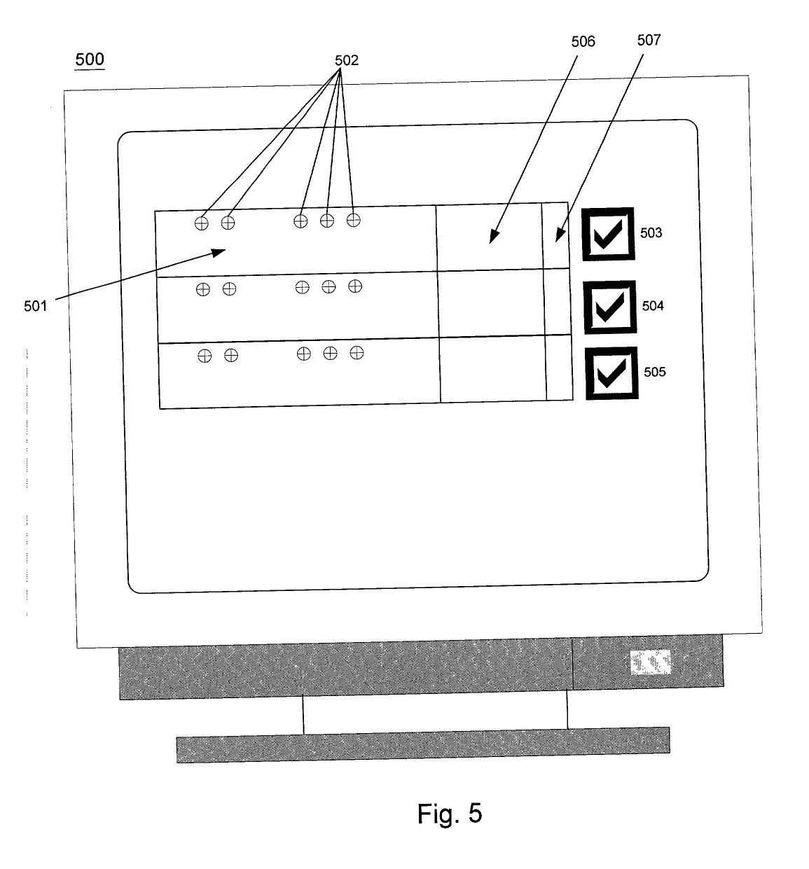

Referring now to FIG. 5, an exemplary GUI for displaying information related to ALARM is illustrated 500. The GUI can include areas prompting for information, such as in the form of a key word or a question 501. Areas can also be included for an appropriate response 506. The area for an appropriate response 506 can, for example, receive text, allow a selection from choices proffered, or otherwise receive data into the ALARM server 210. A programmable user interactive device, such as a checkbox, X field, yes/no filed or other device 503-505 can also be utilized to indicate an answer, or otherwise input information. Other programmable devices, such as programmable icons, hyperlinks, push buttons or other devices 502 can also be utilized to execute a particular function. A category weighting area 507 can also be indicated on the GUI 500. Typically the weighting will be predetermined. However, if desired the weighting can be modified by a user such that a weighting value, such as a numerical value, will be utilized to calculate a risk quotient. The ALARM GUI 500 can also include an area for displaying a quotient score relating to the transaction 508.

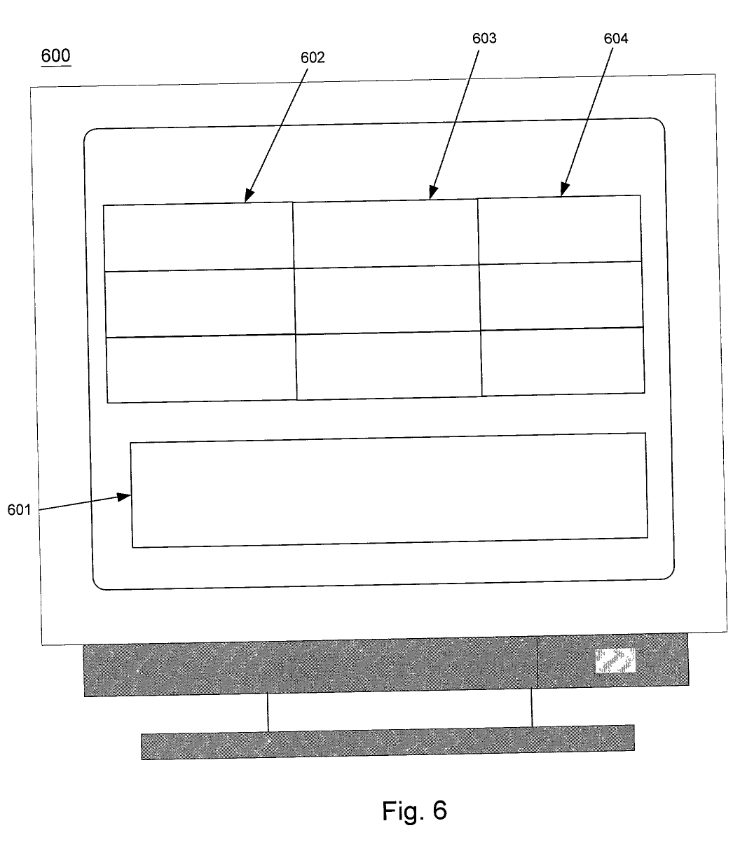

Referring now to FIG. 6, an exemplary GUI for presenting reports or suggested actions related to an ALARM system 115 is illustrated 600. The GUI for presenting reports 600 can include geographic areas of a user interface containing risk management procedures 601, including those procedures specifically followed in relation to a particular ALARM or other suggested actions. Additional areas can include a list of electronic or hardcopy reports available concerning risk management efforts undertaken 602. Another area can include a list of risk quotients and/or calculations concerning a risk quotient, such as the average risk quotient for an institution, or the mean risk quotient 603. Still another area can contain information descriptive of a particular legal action 604.

A number of embodiments of the present invention have been described. Nevertheless, it will be understood that various modifications may be made without departing from the spirit and scope of the invention. For example, network access devices 204-208 can comprise a personal computer executing an operating system such as Microsoft Windows™, Unix™, or Apple Mac OS™, as well as software applications, such as a JAVA program or a web browser. network access devices 204-208 can also be a terminal device, a palm-type computer, mobile WEB access device or other device that can adhere to a point-to-point or network communication protocol such as the Internet protocol. Computers and network access devices can include a processor, RAM and/or ROM memory, a display capability, an input device and hard disk or other relatively permanent storage. Accordingly, other embodiments are within the scope of the following claims.

What is claimed is:

1. A computer-implemented method for managing risk related to a legal action, the method comprising:
receiving information relating to a legal action;
structuring the information received according to risk assessment factors;
assigning a risk value to the information structured as risk assessment factors;
weighting the risk factors according to relative importance; and
calculating a risk quotient based upon the weighted risk factors and the risk value.

2. The method of claim 1 additionally comprising the step of generating a suggested action responsive to the risk quotient.

3. The method of claim 2 additionally comprising the steps of:
storing data indicative of the information received, the risk quotient and the suggested action; and
generating a report comprising the stored data.

4. The method of claim 3 wherein the diligence report comprises information received relating to legal exposure and actions taken responsive to the risk quotient.

5. The method of claim 2 wherein the suggested action is additionally responsive to the information received.

6. The method of claim 2 wherein the suggested actions are directed towards reducing risk related to litigation.

7. The method of claim 2 wherein the suggested action comprises commencing a litigation.

8. The method of claim 2 wherein the suggested action comprises entering arbitration.

9. The method of claim 1 wherein the suggested action comprises settling a legal action claim.

10. The method of claim 1 wherein the information received comprises the identities of parties named in a litigation.

11. The method of claim 1 wherein the information received comprises venue for a legal action.

12. The method of claim 1 wherein the information received is gathered electronically.

13. The method of claim 1 additionally comprising the step of aggregating risk quotients relating to an entity and assessing a level of risk related to legal actions to which the entity is exposed.

14. The method of claim 13 additionally comprising the step of calculating an average risk quotient associated with an entity.

15. The method of claim 1 wherein the legal action comprises a class action suit.

16. A computerized system for managing risk associated with a legal action, the system comprising:
a computer server accessible with a network access device via a communications network; and
executable software stored on the server and executable on demand, the software operative with the server to cause the system to:
receive information relating to a legal action;
structure the information received according to risk assessment factors; and
assign a risk value to the information structured as risk assessment factors;
weight the risk factors according to relative importance; and
calculate a risk quotient based upon the weighted risk factors and the risk value.

17. The computerized system of claim 16 wherein the information is received via an electronic feed.

18. The computerized system of claim 16 wherein the network access device is a personal computer.

19. The computerized system of claim 16 wherein the network access device is a wireless handheld device.

20. Computer executable program code residing on a computer-readable medium, the program code comprising instructions for causing the computer to:
receive information relating to a legal action;
structure the information received according to risk assessment factors; and
assign a risk value to the information structured as risk assessment factors;
weight the risk factors according to relative importance; and
calculate a risk quotient based upon the weighted risk factors and the risk value.

21. A computer data signal embodied in a digital data stream comprising data relating to legal action risk management, wherein the computer data signal is generated by a method comprising the steps of:
receiving information relating to a legal action;
structuring the information received according to risk assessment factors;
assigning a risk value to the information structured as risk assessment factors;
weighting the risk factors according to relative importance; and
calculating a risk quotient based upon the weighted risk factors and the risk value.

22. A method of interacting with a network access device so as to manage risk relating to a legal action, the method comprising the steps of:
initiating interaction with a host computer on a communications network;
transferring information relating to a legal action via a graphical user interface to a automated legal action risk management server; and
and receiving a risk quotient indicative of a level of risk associated with the legal action.

23. The method of claim 22 wherein the risk quotient is a numerical value.
